(19) United States
(12) Patent Application Publication
(10) Pub. No.: US 2010/0321147 A1
(43) Pub. Date: Dec. 23, 2010

(54) Vanadium sesquioxide nanocomposite

(76) Inventors: Ahmed Abdullah S. Al-Ghamdi, Jeddah (SA); El-Sayed Ed-Badaway H. El-Mossalamy, Jeddah (SA); Farid Mahmoud El-Tantawy, Balgam (SA); Nadia Abdel Aal, Al-Baha (SA)

Correspondence Address: LITMAN LAW OFFICES, LTD., PATENT LAW BUILDING, 8955 CENTER STREET, MANASSAS, VA, 20110, US

(21) Appl. No.: 12/457,851

(22) Filed: Jun. 23, 2009

(51) Int. Cl. H01B 1/20; C01G 31/02; B29C 39/38; H01C 7/13; H01H 71/00

(52) U.S. Cl. 338/22 R; 252/519.33; 423/594.17; 264/319; 337/14; 977/955

(57) ABSTRACT

The vanadium sesquioxide nanocomposite is useful for applications in thermistors, current switching devices, static charge dissipation devices, and electromagnetic shielding. Vanadium sesquioxide nanoparticles are produced using a sol-gel process that results in a V₂O₅ gel. The gel is heated in a reducing atmosphere of about 5% H2-95% argon at 850° C. for about four hours. The resulting product is dried at about 50° C. for twenty-four hours to produce V₂O₃ powder having particles about 23 nm in size. The nanocomposite is prepared by mixing the sesquioxide nanoparticles with epoxy resin and hardener in a centrifuge, casting the mixture in a Teflon mold, heating the mixture at 60° C. for 30 minutes, and curing the product at 150 KN/m2 at 100° C. for two hours. The nanocomposite contains about 80-90 wt % epoxy resin-hardener mixture and about 10-20 wt % vanadium sesquioxide nanoparticles.

### BACKGROUND OF THE INVENTION

1. Field of the Invention

The present invention relates to conductive nanocomposites, and particularly to a vanadium sesquioxide nanocomposite useful for applications in thermistors, current switching devices, static charge dissipation devices, and electromagnetic shielding. The present invention also relates to a novel sol-gel process for preparing nanoparticles of vanadium sesquioxide.

2. Description of the Related Art

Ceramic metal oxides have been shown to possess interesting electrical properties that have potential utility for electrical applications. These properties, e.g., conductivity and its reciprocal, resistivity, often depend upon the particular metal and its oxidation state, the method of forming the ceramic oxide (from gaseous materials, by microwave plasma, by sol-gel, including the temperature range that the metal is heated, the duration of heating, whether the process is performed under vacuum or pressure, the presence or absence of an oxidizing or reducing atmosphere, etc.), the nature of the product (gel, thin film, powder, etc.), and other factors. Since ceramic metal oxides, particularly transition metals, are also brittle and sometimes difficult to draw into a wire, the must also be fixed or embedded into a support, such a plating onto an electrode for use in batteries, applying in a thin layer to the surface of a support for infrared sensors or the like, mixing with electrolytes to form a dielectric material for a capacitor, or dispersing nanosized particles into a polymer matrix to form a conductive nanocomposite. The electrical properties, particularly conductivity and resistivity, of the resulting nanocomposite may often be affected by interactions between the metal oxide and the polymer(s) in which the metal oxide is dispersed.

Vanadium oxide is a transition metal oxide that is sometimes prepared with a valence of two (VO2, or vanadium dioxide), three (V2O3, or vanadium sesquioxide), five (V2O5, or vanadium pentoxide), or mixtures thereof. The forming processes have included powders formed by microwave plasma, thin films formed by sol-gel, etc., but the inventors are not aware of vanadium sesquioxide powder being formed by a sol-gel process, and certainly not by the process conditions described below and having the electrical properties described herein.

Thus, a vanadium sesquioxide nanocomposite solving the aforementioned problems is desired.

### SUMMARY OF THE INVENTION

The vanadium sesquioxide nanocomposite is useful for applications in thermistors, current switching devices, static charge dissipation devices, and electromagnetic shielding. Vanadium sesquioxide nanoparticles are produced using a sol-gel process that results in a V₂O₅ gel. The gel is heated in a reducing atmosphere of about 5% H2-95% argon at 850° C. for about four hours. The resulting product is dried at about 50° C. for twenty-four hours to produce V₂O₃ powder having particles about 23 nm in size. The nanocomposite is prepared by mixing the sesquioxide nanoparticles with epoxy resin and hardener in a centrifuge, casting the mixture in a Teflon mold, heating the mixture at 60° C. for 30 minutes, and curing the product at 150 KN/m2 at 100° C. for two hours. The nanocomposite contains about 80-90 wt % epoxy resin-hardener mixture and about 10-20 wt % vanadium sesquioxide nanoparticles.

Various samples of the nanocomposite were prepared with the vanadium sesquioxide concentration ranging between 0 wt % and 20 wt %. Above about 8 wt %, the nanocomposite sample showed a decrease in resistivity that was 16 orders of magnitude less than pure epoxy resin. Above 20 wt %, the dielectric constant increase to the point that no dielectric effect is observed, and the resistivity and conductivity become constant. Between about 8% and 20%, the dielectric constant is increasing while resistivity decreases.

Testing of nanocomposite samples between about 8 wt % and 20 wt % vanadium sesquioxide showed a sharp, positive increase in the temperature coefficient of resistivity, which suggests applications as thermistors, temperature probes, temperature sensors, and other electrothermal applications. Measurement of current vs. applied voltage at constant temperature for vanadium sesquioxide concentrations in the above range showed a linear increase of current with voltage up to a peak switching value, beyond which the relationship is no longer linear, suggesting the nanocomposite samples are useful for switching applications. The nanocomposite samples between 10 wt % and 20 wt % of vanadium sesquioxide also showed high attenuation values between 1 GHz and 12 GHz, which suggests their use for antistatic charge dissipation and electromagnetic shielding in the microwave region.

These and other features of the present invention will become readily apparent upon further review of the following specification and drawings.

### BRIEF DESCRIPTION OF THE DRAWINGS

FIG. 1 is a chart showing X-ray diffraction patterns (intensity vs. angle) for different vanadium sesquioxide/epoxy resin compositions in a vanadium sesquioxide nanocomposite according to the present invention.

FIG. 2 is a chart showing the variation in glass transition temperatures (Tg), packing factor (F), degree of crystallinity (C), hardness (γ), and sound velocity (SV) as a function of vanadium sesquioxide concentration in a vanadium sesquioxide nanocomposite according to the present invention.

FIG. 3 is a chart showing resistivity and dielectric constant as a function of vanadium sesquioxide concentration in a vanadium sesquioxide nanocomposite according to the present invention.

FIG. 4 is a chart showing resistivity as a function of temperature for nanocomposite samples having concentrations of 10 wt % (V10), 15 wt % (V15), and 20 wt % (V20), respectively, in a vanadium sesquioxide nanocomposite according to the present invention.

FIG. 5 is a chart showing activation energies (Ea), hopping energies (Eh), Seebeck coefficient (S) and number of charge carriers as a function of vanadium sesquioxide concentration in a vanadium sesquioxide nanocomposite according to the present invention.

FIG. 6 is a chart showing the variation of resistivity as a function of time at 50° C. for nanocomposite samples having concentrations of 10 wt % (V10), 15 wt % (V15), and 20 wt % (V20), respectively, in a vanadium sesquioxide nanocomposite according to the present invention.

FIG. 7 is a chart showing thermogravimetric analysis (TG) and differential thermal analysis (DTA) nanocomposite samples having concentrations of 0 wt % (1 Green epoxy), 10 wt % (V10), and 20 wt % (V20), respectively, of vanadium sesquioxide in a vanadium sesquioxide nanocomposite according to the present invention.

FIG. 8 is a chart showing current as a function of applied d.c. voltage for nanocomposite samples having concentrations of 10 wt % (V10), 15 wt % (V15), and 20 wt % (V20), respectively, and ultimate temperature characteristic (I/V/T) as a function of applied d.c. voltage for nanocomposite samples having concentrations of 10 wt % (V10-T), 15 wt % (V15-T), and 20 wt % (V20-T), respectively, in a vanadium sesquioxide nanocomposite according to the present invention.

FIG. 9 is a chart showing shielding efficiency both theoretical (Theo.) and experimental (Exp.), as a function of frequency in the gigahertz range for nanocomposite samples having concentrations of 10 wt % (V10), 15 wt % (V15), and 20 wt % (V20), respectively, in a vanadium sesquioxide nanocomposite according to the present invention.

Similar reference characters denote corresponding features consistently throughout the attached drawings.

### DETAILED DESCRIPTION OF THE PREFERRED EMBODIMENTS

The vanadium sesquioxide nanocomposite is useful for applications in thermistors, current switching devices, static charge dissipation devices, and electromagnetic shielding. Vanadium sesquioxide nanoparticles are produced using a sol-gel process that results in a V₂O₅ gel. The gel is heated in a reducing atmosphere of about 5% H₂-95% argon at 850° C. for about four hours. The resulting product is dried at about 50° C. for twenty-four hours to produce V₂O₃ powder having particles about 23 nm in size. The nanocomposite is prepared by mixing the sesquioxide nanoparticles with epoxy resin and hardener in a centrifuge, casting the mixture in a Teflon mold, heating the mixture at 60° C. for 30 minutes, and curing the product at 150 KN/m2 at 100° C. for two hours. The nanocomposite contains about 80-90% epoxy resin-hardener and about 10-20% vanadium sesquioxide nanoparticles.

Various samples of the nanocomposite were prepared with the vanadium sesquioxide concentration ranging between 0 wt % and 20 wt %. Above about 8 wt %, the nanocomposite sample showed a decrease in resistivity that was 16 orders of magnitude less than pure epoxy resin. Above 20 wt %, the dielectric constant increase to the point that no dielectric effect is observed, and the resistivity and conductivity become constant. Between about 8% and 20% the dielectric constant is increasing while resistivity decreases.

Testing of nanocomposite samples between about 8 wt % and 20 wt % vanadium sesquioxide showed a sharp, positive increase in the temperature coefficient of resistivity, which suggests applications as thermistors, temperature probes, temperature sensors, and other electrothermal applications. Measurement of current vs. applied voltage at constant temperature for vanadium sesquioxide concentrations in the above range showed a linear increase of current with voltage up to a peak switching value, beyond which the relationship is no longer linear, suggesting the nanocomposite samples are useful for switching applications. The nanocomposite samples between 10 wt % and 20 wt % of vanadium sesquioxide also showed high attenuation values between 1 GHz and 12 GHz, which suggests their use for antistatic charge dissipation and electromagnetic shielding in the microwave region.

The principles of the vanadium sesquioxide nanocomposite will now be illustrate by a description of the synthesis of a nanoparticle powder of vanadium sesquioxide, and by a description of tests of the properties of the nanocomposite at various concentrations of vanadium sesquioxide in the epoxy resin matrix.

### EXAMPLE 1

### Preparation of V₂O₃

V₂O₃ nanoparticles were synthesized by heat treating sol-gel derived vanadium oxide nanopowder in reducing atmospheres. In a typical procedure, 1.0 g of V₂O₅ powder was dissolved in 30 ml of 30% H₂O₂ solution under vigorous magnetic stirring at room temperature. Red brown viscous gels formed within three days by heating the solution at 85° C., with the pH being controlled at around 2.0 by periodic addition of H₂O₂ as needed. V₂O₃ powders were formed by heating the V₂O₅ gel in a 5% hydrogen-95% argon gas mixture at 850° C. for about 4 hours. After being dried in vacuum at 50° C. for 24 hours, the final black powder products were obtained. The powder had a particle size of about 23 nm.

### EXAMPLE 2

### Preparation of Nanocomposites

The polymer used in this investigation was a commercial bisphenol A-type epoxy resin (Epikote 828) and a casting hardener (type B002W), which were supplied by Yuka Shell Epoxy Co., Ltd. of Tokyo, Japan. A stoichiometric resin/hardener ratio of 100:20 by weight was used according to the manufacturer's data sheets. V₂O₃ powder with particle size of about 23 nm was received from the method of Example 1. Several batches of epoxy resin:V₂O₃ weight ratios were considered, including 90:10, 95:15, and 80:20, respectively, and abbreviated as V10, V15, and V20, respectively. The green epoxy-hardener with different contents of vanadium sesquioxide filler were prepared by mixing in a centrifuging mixer at 4000 rpm for 2 minutes at room temperature. The bulk samples of nanocomposite were obtained by casting the green composites into Teflon molds, which were placed in an electrical oven that was preheated to 60° C. for 30 minutes. Then, the epoxy resin/vanadium sesquioxide filler nanocomposites were cured under hot uniaxial pressure 150 KN/m² at 100° C. for 2 hours.

### EXAMPLE 3

### Testing of Nanocomposites

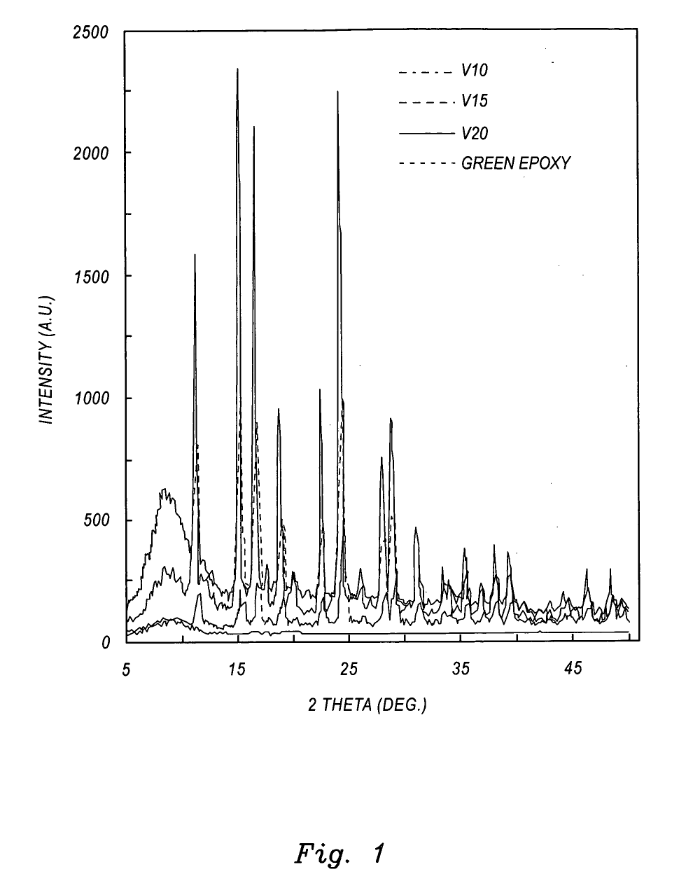

The room temperature XRD patterns of green epoxy (0 wt % V₂O₃) and epoxy/V₂O₃ samples with different compositions are shown in FIG. 1. Compared with green epoxy, the intensity of the V₂O₃ phase increased with an increase in the V₂O₃ content in the nanocomposites. This implies that the distribution of V₂O₃ in the sample was homogenous.

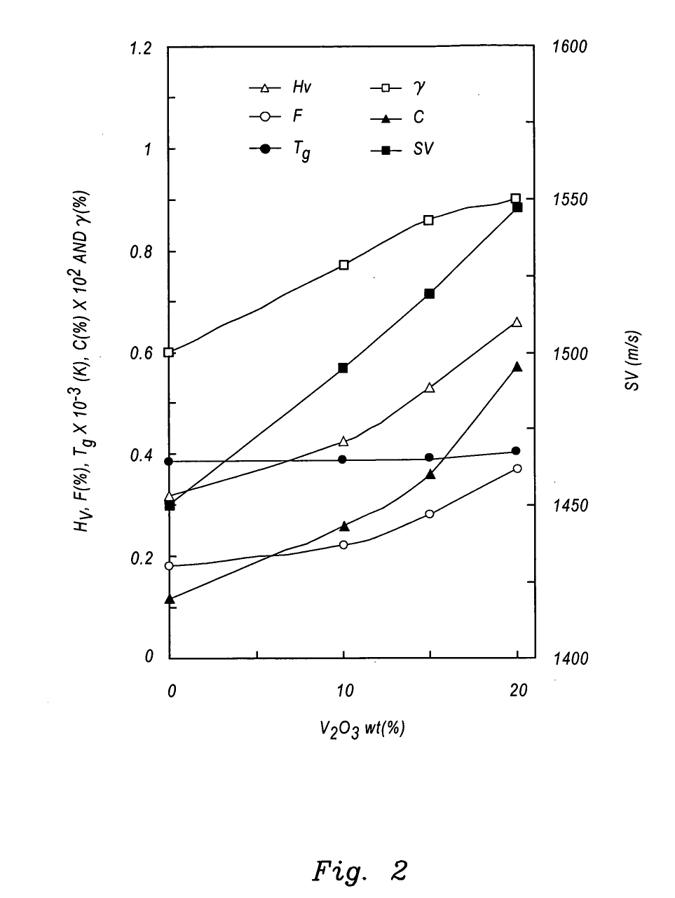

As expected, the V₂O₃ is more dispersed, sinking into the epoxy matrix and forming a more continuous phase in the nanocomposites as a result of good interfacial adhesion. This was verified by scanning electron microscopy images of the nanocomposites. The crystallinity (C) of the filler in the nanocomposites increases with an increase in the V₂O₃ loading levels, as shown in the chart in FIG. 2. The increase of crystallinity with increase in V₂O₃ content indicates that the inclusion of V₂O₃ nanoparticles improves the molecular structure of epoxy resin. In FIG. 2, we also observe the increase in the packing factor (F) with the increase in V₂O₃ loading levels, which may be explained by the decrease of free volume as a function of the nanoparticle content, which was also confirmed by SEM images. This may also be ascribed to the strong adhesion force between neighboring chains, and to filler/matrix interactions in the nanocomposite.

It is realized that the extent of filler reinforcement increases with increase of V₂O₃ in epoxy matrix, as shown in FIG. 2. This is attributed to the integrated interfacial bonding and good wettability between filler and matrix due to the higher surface area of the V₂O₃ particles.

The glass transition temperature (Tg) as a function of V₂O₃ content is also depicted in FIG. 2. The glass transition temperature yields the relative stiffness, i.e., the higher glass transition temperature, the greater the polymer chain stiffness. In addition, glass transition temperature increase also is due to a decrease of thermal stress across the epoxy domains, which is attributed to differences in thermal expansion coefficients of the nanocomposites, resulting in a positive pressure of the epoxy domains. This is also associated with a decrease of free volume of the epoxy component, and therefore with a decrease of motion ability of the epoxy molecules, as confirmed by the hardness (γ) results in FIG. 2. Hardness increased with increase in V₂O₃ content. This is ascribed to V₂O₃ particles reducing the creep of the epoxy matrix, and thereby enhanced network structure stability within the epoxy matrix.

For further confirmation the above facts, the sound velocity (SV) as a function of V₂O₃ content is shown in FIG. 2. The sound velocity increases with increase in V₂O₃ in the composite. This is expected, as both crosslinking density and interfacial adhesion in the samples will increase with increase in V₂O₃ content, which leads to an increase of the sound velocity. On the other hand, the increase of the sound velocity can also be ascribed to facile mobility carriers and the filler/polymer interaction, which induces the rigidity of the polymer chains. This implies that chain connectivity and interfacial adhesion increases in the nanocomposites with an increase in V₂O₃ content.

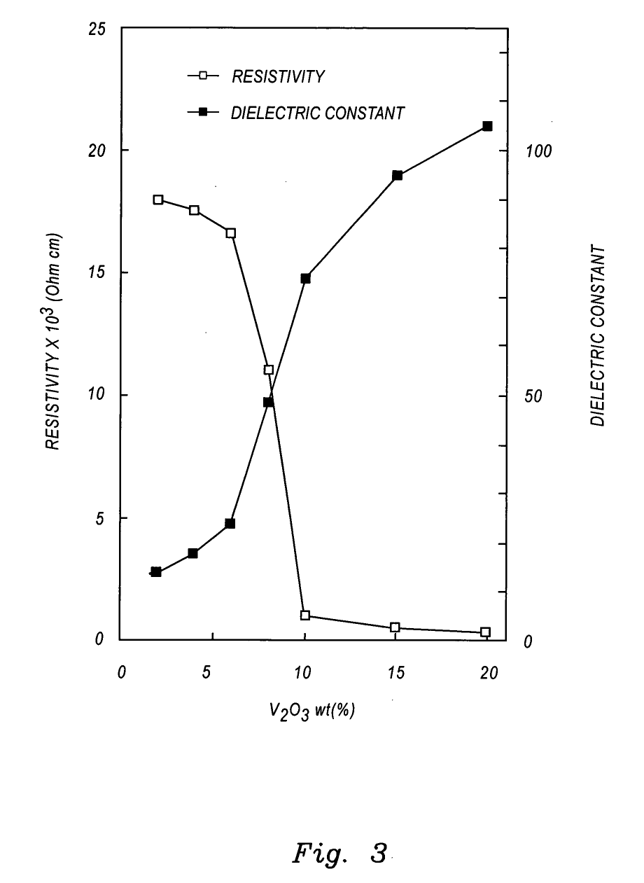

The volume resistivity of the epoxy/V₂O₃ composites as a function of the weight percentage of the V₂O₃ is shown in FIG. 3. An insulator-to-conductor transition is observed when the V₂O₃ concentration increases. This plot shows a typical percolation phenomenon. When the amount of V₂O₃ reaches about 8 wt %, the resistivity of the nanocomposite is lower than that of the green epoxy without the V₂O₃ nanoparticle filler (the conductivity of green epoxy is 0.25×10-13 S/m) by 16 orders of magnitude. As the amount of V₂O₃ increases, conductive networks appear in the material and the macroscopic conductivity is sharply increased.

Further, the reduction of resistivity with the increase of conductive filler content is attributed to the enhanced mobility of charge carriers. The increase of conductive phase content results in smaller intermolecular distance between conductive sites. This leads to the decreasing electrical resistivity of the nanocomposites. It is interesting to note that a conductivity plateau was detected in our results and was attributed to the presence of a superstructure of flocculated filler particles. However, the phenomenon demonstrates that the percolation threshold in the conductivity of the nanocomposite is less than 8 wt %.

The dielectric constant as a function of V₂O₃ weight percentage of the composites is also plotted in FIG. 3. Concurrently, beyond the percolation threshold, the dielectric constants increase strongly and diverge. Qualitatively, this phenomenon can be interpreted as follows. Near the percolation threshold, conductive phases are separated by thin dielectric regions. The effective surface of the condensers, which are formed by neighboring conducting phases, tends to infinity when the V₂O₃ content increases. Then the effective capacity (and consequently the dielectric constants) of the samples diverge. It is worthy to note that the dielectric constants reaches 102 when the weight percentage of the V₂O₃ is 20 wt %. This is 37 times that of green epoxy. This is ascribed to the interfacial polarization and chain segment mobility increases with the increase in V₂O₃ content in the nanocomposites.

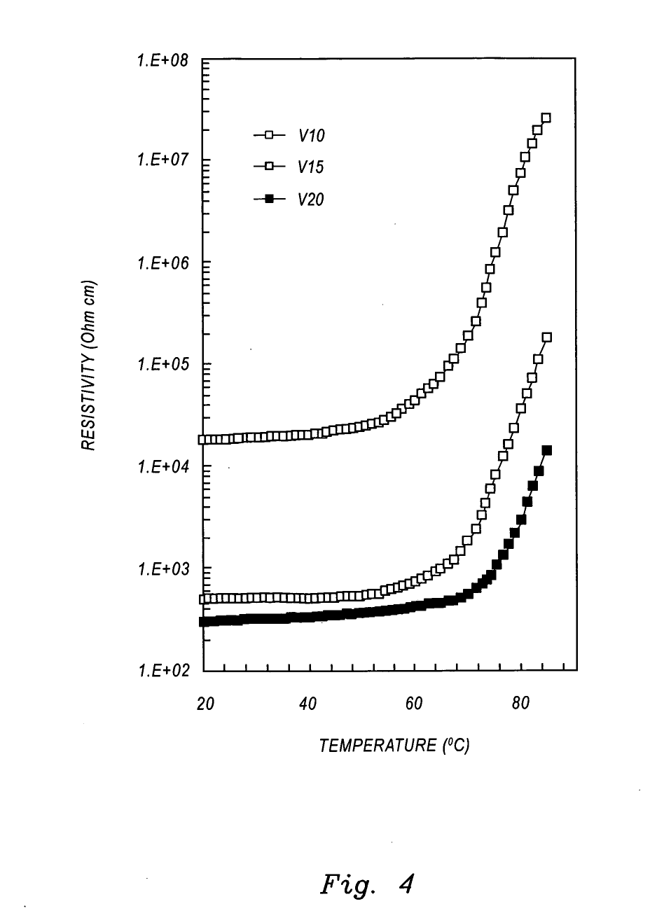

The positive increase in electrical resistivity of the epoxy/V₂O₃ nanocomposites at elevated temperatures can be used to design “electrical self-regulating heating” materials. The resistivity vs. temperature characteristics of the nanocomposites is presented in FIG. 4. A sharp resistivity increase is generally seen at relatively high temperatures and has been termed the positive temperature coefficient (PTC) effect of resistivity. The increase of resistivity with temperature is ascribed to the increase of interaggregate distance between V₂O₃ particles, and to thermal expansion of the epoxy matrix. The PTC effect of resistivity is attributed to a reduction in the intergranular charge carrier's transport that accompanies a change in the tunneling path at high temperature.

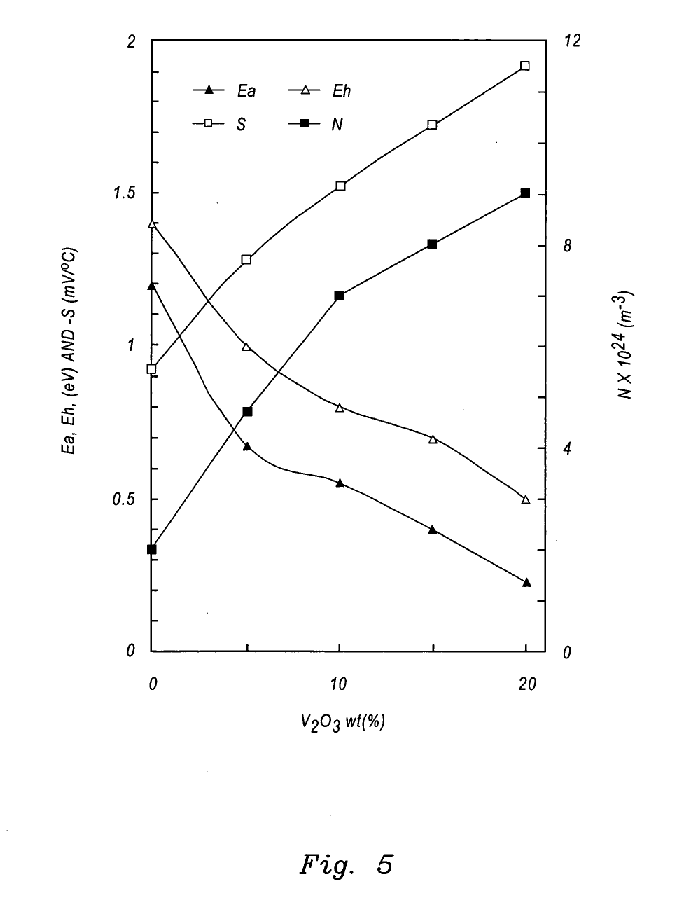

Clearly, a closer examination of the hopping and activation energies as a function of filler content is necessary to gain insight into the conduction process. The values of activation energies have been calculated using least square fitting of the slopes of the log of resistivity versus the inverse of temperature data for various concentrations in the temperature range 25°-70° C. and are shown in FIG. 5. The values of the activation energies of conduction for these samples lie in the range of 0.23-0.67 eV. Activation energy decreases with the increase in filler content due to the increase of the charge carrier concentration and to the decrease of localized states in the band gap. As the concentration of filler increases, activation energy starts decreasing, whereas resistivity decreases with filler concentration. Thus, increase of filler decreases the resistivity not only due to the carrier concentration, but perhaps also due to the enhanced mobility of the charge carriers, which occurs at higher loading levels due to the increased interchain transport.

This fact is confirmed by computation of the concentration of charge carriers as a function of filler content in the nanocomposites, as shown in FIG. 5. This is expected, as both the interchain transport and mobility carriers in the samples will increase with an increase in V₂O₃ content, which leads to an increase of the concentration of charge carriers. The calculated values of the Eₕ as a function of V₂O₃ content is depicted in FIG. 5. It is clear that the values of Eₐ are different from Eₕ in the composites. This clue supports the conclusion that the mechanism of conductivity in the composites is controlled by a tunneling mechanism. To understand the type of charge carriers in nanocomposites, we measured the Seebeck coefficient. The value of Seebeck coefficient (S) versus filler content of the nanocomposites is plotted in FIG. 5. It is clear that the value of S is negative. This is a strong clue that the charge carriers' transport in composites is controlled by electrons.

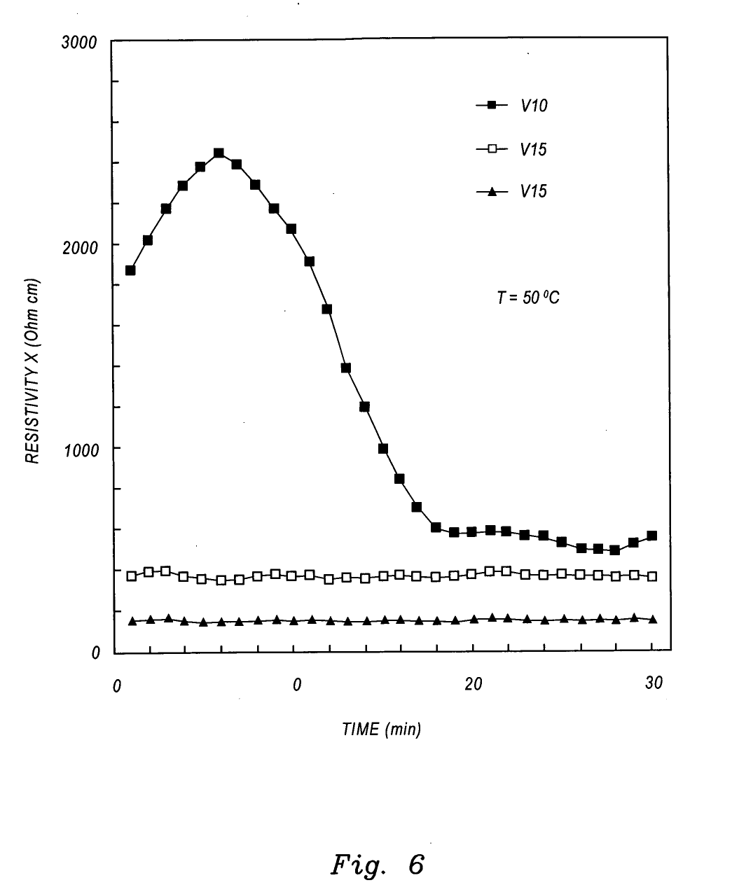

To explain the influence of V₂O₃ on the network structure, an isothermal stability test of the nanocomposites by monitoring the variation of resistivity versus time at a fixed temperature was conducted to obtain more information concerning interfacial bonding between filler and matrix. First, the variation of electrical resistivity of the composites as a function of time at 50° C. was monitored, and the results are shown in FIG. 6. The curve for the V10 sample shows two distinct steps of loss in electrical resistivity. A rapid increase in resistivity occurs up to about 10 minutes, and thereafter a rapid decrease and then level off is observed. The initial increase of resistivity is inferred to be due to the volumetric thermal expansion of the epoxy matrix. For the V15 and V20 samples, there is little change in resistivity at this temperature up to 20 minutes. Thereafter, the resistivity remains steady with time. The above results indicate that an increase of V₂O₃ content increases interfacial bonding between filler and matrix.

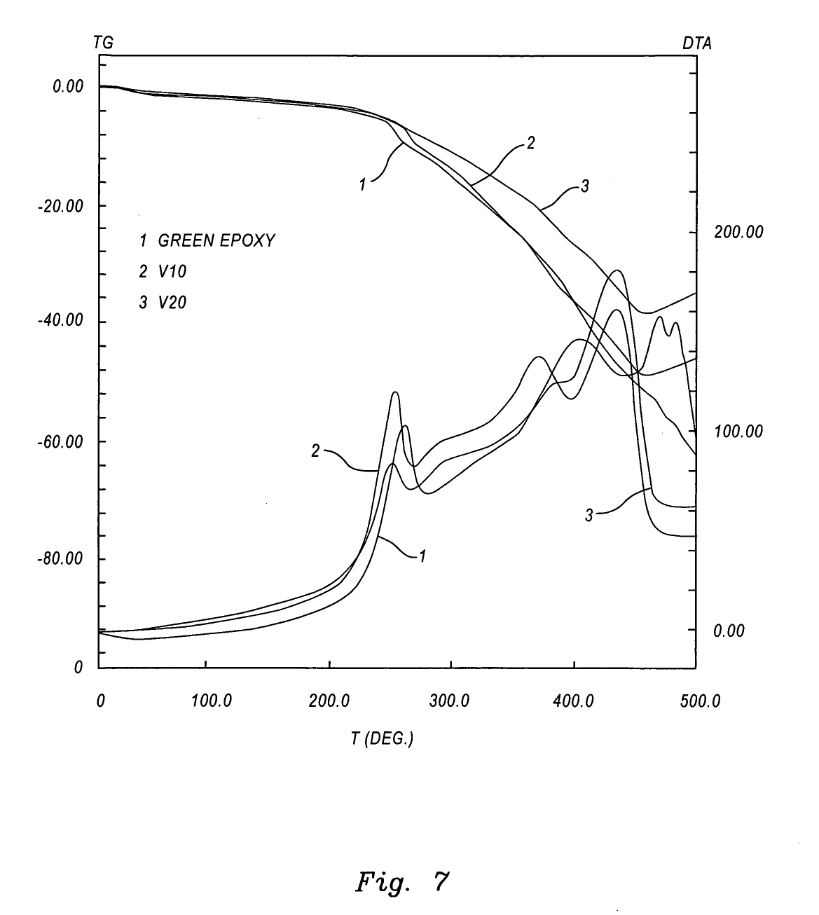

Again, the epoxy matrix charged with V₂O₃ nanoparticles has a higher thermal stability than the uncharged epoxy polymer. This assertion is based on analysis of the thermal gravimetry (TG) and differential scanning calorimetry (DTA) diagrams of the nanocomposites, as shown in FIG. 7. TG curves of green epoxy and the V10 and V20 sample nanocomposites indicated that the samples present a higher initial degradation temperature than plain green epoxy. However, the onset decomposition temperatures of the nanocomposites are higher than the plain green epoxy and are shifted towards a higher temperature range as the V₂O₃ content of the nanocomposites increases. These behaviors are assigned to the barrier effect of the filler particles, and thus hinder the degradation process. The slight increase in the decomposition temperature with the increase of V₂O₃ content in the nanocomposite may be explained by the increase of its degree of crystallinity (C), as supported above in FIG. 2. The DTA patterns show that the temperature at which thermal decomposition of the nanocomposite containing 20% V₂O₃ particles occurs is 388.90° C., compared with 315.30° C. for the plain green epoxy sample. This result once again endorses the high thermal stability of nanocomposites at high V₂O₃ loading levels.

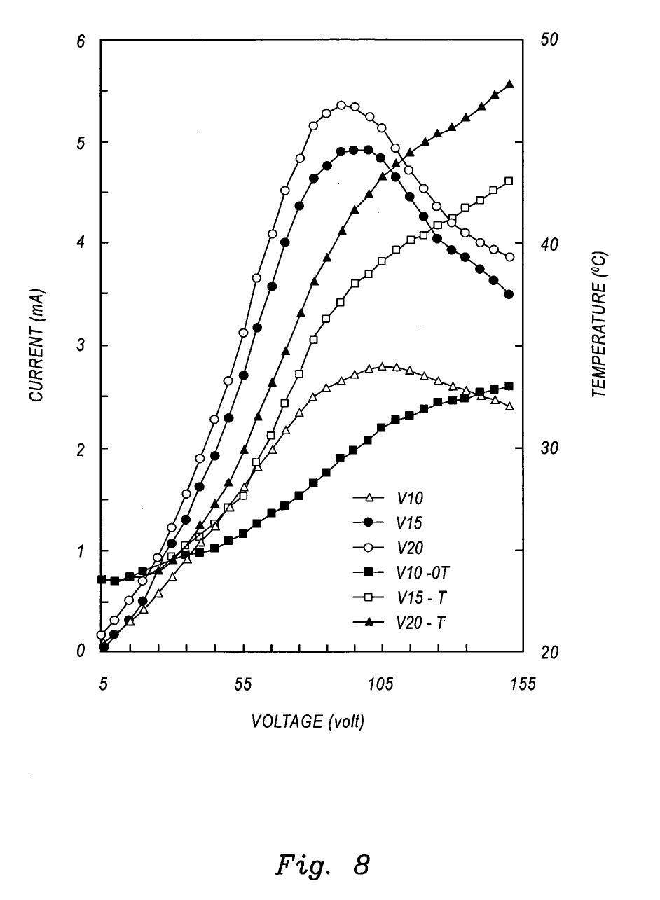

FIG. 8 presents a typical current versus dc voltage and ultimate temperature characteristic (I/V/T) curve for the nanocomposites at a room temperature of 25° C. It is clear that the current curves (V10, V15, and V20) show a peak point (i.e., a switching point), after which the curves exhibit what is referred to as negative resistance. In this curve, the left side of the peak point is an Ohmic region (i.e., a linear region), whereas the right side is a varistor region. In the Ohmic region, a steady-state operating condition is maintained. In this condition, the nanocomposite is in thermal equilibrium and no self-heating takes place. However, in the varistor region, the nanocomposite becomes self-heating due to the Joule heating effect. When the voltage exceeds a certain value that depends on filler concentration, the thermal equilibrium fails and the nanocomposite quickly switches to the peak state (namely, the switching current).

With an increase of the electric field, the behavior of the I-V curve changes from Ohmic to non-Ohmic. This is attributed to the change in the percolation conductive network across the epoxy matrix, and to thermal fluctuations due to significant Joule heating that took place so that nonlinearity that set in. Increasing the electric field above a certain voltage, termed peak, and which depends on filler content, leads to an increase in the Joule heating effect, and consequently increases the sample's temperature and decreases the current, i.e., showing negative resistance.

According to the results of the V/T experiment, shown in FIG. 7, the maximum temperature is 50° C. for the V20 sample. It is interesting to note that the variation of temperature with applied potential is linear, which makes the proposed nanocomposites very useful for temperature probe. The results in FIGS. 7 and 8 also imply that the proposed nanocomposite is useful for low-voltage power regulation systems, such as battery-operated motors, spark quenching, and low-voltage electronic switches.

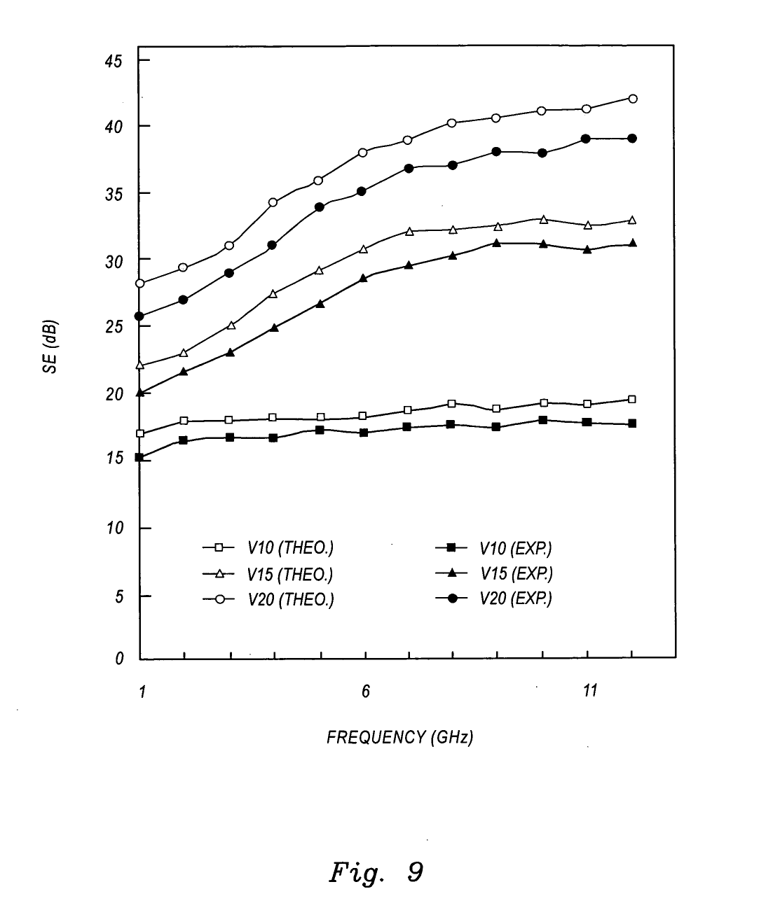

The shapes of both experimental and theoretically calculated SE, shown in FIG. 9, are similar (the experimental values were obtained by testing EMI shielding having a surface thickness of about 0.1 mm). The curves do show a difference in the absolute value for each experimentally determined value versus the theoretical value. This difference between the theoretical and measured values is expected, and may be attributed to the surface irregularity of absorber sample, the gap between the sample and wave-guide dimensions, an air gap between the sample matrix and metal filler, and certain voids present in the sample, which were confirmed by SEM image. High SE attenuation values (42 dB) in the frequency range of 1-12 GHz were obtained when the nanocomposites contained 20 wt % of the V₂O₃/epoxy nanocomposite (V20). Also, the nanocomposite containing 15 wt % of nanocomposite (V15) presents SE attenuation values between 22 and 33 dB in the frequency range of 1-12 GHz. In this case, the nanocomposite exhibits a broadband behavior, showing microwave radiation absorption.

Hence, the reflectivity properties of the conductive epoxy nanocomposites depend on nanocomposite composition and the microstructure attained after processing. In this case, the V₂O₃/epoxy nanocomposite agglomerates between the resin phases affect the wave-matter interaction. This shows that these conductive V₂O₃/epoxy nanocomposites are an effective absorber in the microwave range.

In addition, the V₂O₃/epoxy nanocomposite with 10% V₂O₃ content (V10) presents lower microwave absorbing properties between 1 and 12 GHz. However, the conducting nanocomposite presents a shift of the attenuation values to higher frequencies, specifically the maximum of the attenuation values occur at frequencies higher than 12 GHz. These results suggest that the nanocomposite with 20 wt % V₂O₃ content may be useful for antistatic discharge and electromagnetic shielding applications in the microwave region, achieving attenuation up to 42 dB in the 1-12 GHz region. For electromagnetic shielding, it is preferred that the shielding be applied as a surface coating having a thickness of about 0.1 mm.

In summary, the conductive nanocomposites containing epoxy resin reinforced V₂O₃ nanoparticles are useful for various technological applications, such as positive temperature coefficient (PTCR) thermistors, current switching devices, and electromagnetic shielding. A new chemical route of synthesizing V₂O₃ nanoparticles has been presented that is a very simple and economic mode for mass production. Furthermore, the chemical method, i.e., a sol-gel method heating the product in a reducing atmosphere, i.e., in a 5% hydrogen-95% argon gas mixture at 850° C. for 4 hours, provides a powder having a particle size of about 23 nm.

In the nanocomposites, it is observed that the V₂O₃ nanoparticles are more dispersed, sinking into the epoxy resin matrix and forming a more continuous phase in the nanocomposites as a result of good interfacial adhesion. The crystallinity, packing factor, and extent of filler reinforcement increase with increasing loading levels of V₂O₃, which indicates that the inclusion of V₂O₃ nanoparticles improves the molecular structure of the epoxy resin and acts as a bonding and or reinforcing agent in the epoxy resin matrix. Also, the glass transition temperature and hardness of the nanocomposites increase with increasing V₂O₃ content.

According to the above structure and properties, it becomes possible to provide a good, conductive, nanocomposite structural material having excellent structural and mechanical properties and excellent thermal stability. The percolation threshold for electrical conductivity of the nanocomposite is less than 8 wt %. The dielectric constants of the nanocomposite samples reach 102 when the weight percentage of the V₂O₃ is 20 wt %, which is 37 times that of plain green epoxy without V₂O₃ nanoparticles. This high value makes it possible to provide super-capacitor conducting nanocomposites having especially excellent electrical properties.

The positive increase in electrical resistivity of the epoxy/V₂O₃ nanocomposites at elevated temperatures may be used to design electrical self-regulating heating or thermal materials and devices. A sharp electrical resistivity increase is generally seen at relatively high temperature and has been termed the “positive temperature coefficient” (PTC) effect of electrical resistivity, useful for temperature probes, thermistors, sensors, and the like.

The current versus dc voltage and ultimate temperature characteristic (I/V/T) behaviors of the nanocomposites at a room temperature of 25° C. exhibit a peak point (i.e., a switching point), which is referred to as the negative resistance. This behavior makes it possible to use the vanadium sesquioxide nanocomposites as switching current and/or voltage devices at low applied voltage potentials for microelectronic applications with good reliability.

High SE attenuation values (about 42 dB) in the frequency range of 1-12 GHz, were obtained when the nanocomposites contained 20 wt % of the V₂O₃ in the epoxy-based nanocomposite (V20). It is preferred that the thickness of the surface of the EMI Shielding be about 0.1 mm. This makes it possible to attenuate electromagnetic waves up to about 42 dB, so that it is possible to provide electromagnetic shielding conducting nanocomposites having especially excellent electro-magnetic properties.

It is to be understood that the present invention is not limited to the embodiments described above, but encompasses any and all embodiments within the scope of the following claims.

We claim:

1. A vanadium sesquioxide nanocomposite, comprising a filler of vanadium sesquioxide (V₂O₃) nanoparticles disposed in a matrix of epoxy.

2. The vanadium sesquioxide nanocomposite according to claim 1, wherein the vanadium sesquioxide nanoparticles have a particle size of about 23 nm.

3. The vanadium sesquioxide nanocomposite according to claim 1, wherein the vanadium sesquioxide nanoparticles are a powder produced by a sol-gel process.

4. The vanadium sesquioxide nanocomposite according to claim 1, wherein the vanadium oxide nanoparticles comprise between about 8% to 20% by weight of an epoxy resin-hardener mixture used to form the epoxy matrix.

5. A thermistor having a positive temperature coefficient of resistivity made from the vanadium sesquioxide nanocomposite according to claim 1.

6. An electrical current switching component made from the vanadium sesquioxide nanocomposite according to claim 1.

7. An antistatic charge dissipation device made from the vanadium sesquioxide nanocomposite according to claim 1.

8. An electromagnetic interference shield for the microwave region between about 1-12 GHz made from the vanadium sesquioxide nanocomposite according to claim 1, wherein the nanoparticles of vanadium sesquioxide comprise about 20% by weight of an epoxy resin-hardener mixture used to form the epoxy matrix.

9. The vanadium sesquioxide nanocomposite according to claim 1, wherein the epoxy matrix is formed from a bisphenol A epoxy resin.

10. A method of making nanoparticles of vanadium sesquioxide in powder form, comprising the steps of:
forming a V₂O₅ gel by sol-gel process;
heating the V₂O₅ gel in a 5% hydrogen-95% argon gas mixture at 850° C. to form V₂O₃; and
drying the V₂O₃ in vacuum at 50° C. for 24 hours to obtain the powder.

11. The method of making nanoparticles of vanadium sesquioxide according to claim 10, wherein said heating step is performed for about 4 hours.

12. The method of making nanoparticles of vanadium sesquioxide according to claim 10, wherein the step of forming the V₂O₅ gel by sol-gel process further comprises the steps of:
(a) dissolving V₂O₅ powder in 30% H₂O₂ solution under vigorous magnetic stirring at room temperature;
(b) heating the solution of V₂O₅ powder in H₂O₂ solution at 85° C. to form red-brown viscous gel; and
(c) controlling pH of the solution at around 2.0 by periodic addition of H₂O₂ during step (b).

13. A vanadium sesquioxide nanocomposite comprising nanoparticles of vanadium sesquioxide formed by the method of claim 10 disposed in an epoxy matrix.

14. A method of forming a vanadium sesquioxide nanocomposite, comprising the steps of:
forming a V₂O₅ gel by sol-gel process;
heating the V₂O₅ gel in a 5% hydrogen-95% argon gas mixture at 850° C. to form V₂O₃; and
drying the V₂O₃ in vacuum at 50° C. for 24 hours to obtain a powder containing nanoparticles of vanadium sesquioxide (V₂O₃);
preparing a mixture of epoxy resin and a casting hardener at stoichiometric ratio;
mixing the epoxy resin-hardener mixture with the nanoparticles of 1l vanadium sesquioxide to obtain a nanocomposite mixture;
casting the nanocomposite mixture into a Teflon mold;
heating the Teflon mold containing the nanocomposite mixture at 60° C.; and
curing the heated nanocomposite mixture at about 100° C. under a pressure of about 150 KN/m².

15. The method of forming a vanadium sesquioxide nanocomposite according to claim 14, wherein said step of mixing the epoxy resin-hardener mixture with the nanoparticles of vanadium sesquioxide further comprises mixing between about 8% to 20% nanoparticles of the vanadium sesquioxide to between about 92% to 80% of the epoxy resin-hardener by weight.

16. The method of forming a vanadium sesquioxide nanocomposite according to claim 14, wherein the vanadium sesquioxide nanoparticles have a particle size of about 23 nm.

17. The method of forming a vanadium sesquioxide nanocomposite according to claim 14, wherein the step of forming the V₂O₅ gel by sol-gel process further comprises the steps of:
(a) dissolving V₂O₅ powder in 30% H₂O₂ solution under vigorous magnetic stirring at room temperature;
(b) heating the solution of V₂O₅ powder in H₂O₂ solution at 85° C. to form red-brown viscous gel; and
(c) controlling pH of the solution at around 2.0 by periodic addition of H₂O₂ during step (b).

18. A thermistor having a positive temperature coefficient of resistivity made from the vanadium sesquioxide nanocomposite formed according to the method of claim 14.

19. An electrical current switching component made from the vanadium sesquioxide nanocomposite formed according to the method of claim 14.

20. An electromagnetic interference shield for the microwave region between about 1-12 GHz made from the vanadium sesquioxide nanocomposite formed according to the method of claim 14, wherein the nanoparticles of vanadium sesquioxide comprise about 20% by weight of an epoxy resin-hardener mixture used to form the epoxy matrix.
